(19) United States
(12) Patent Application Publication
(10) Pub. No.: US 2012/0123920 A1
(43) Pub. Date: May 17, 2012

(54) User Authentication System and Method Thereof

(76) Inventors: Norman M. Fraser, Surrey (GB); Stuart Morris, Berkshire (GB)

(21) Appl. No.: 13/292,624

(22) Filed: Nov. 9, 2011

(30) Foreign Application Priority Data
Nov. 10, 2010 (GB) 1018970.2

(51) Int. Cl. G06Q 30/04; G06F 21/20

(52) U.S. Cl. 705/34; 726/7

(57) ABSTRACT

An authentication system for use in a secure communication system having a verification means (6) for verifying the identity of a user attempting to access a database server (2). In order to complete authentication, the user is required to enter personal authentication data (PAD) into a client terminal (1). The PAD consists of a series of images and the client terminal (1) displays a login screen including a group of user selectable keys each associated with a respective image. At least one of the images associated with a user selectable key is an advertising image and the authentication system is adapted to generate revenue through the use of the advertising image in the login screen.

### FIELD OF THE INVENTION

The present invention relates to a user authentication system and to a user authentication method. More particularly, the present invention relates to an authentication system and method suitable for use as a login interface. The authentication system and method is well suited, but not exclusively so, to e-commerce applications such as online stores.

### DESCRIPTION OF THE RELATED ART

Restricted access online sites and merchant account systems require a login procedure for authenticating users (also referred to as verifying users) requesting access or requiring merchant services. Commonly, the identity of a user is verified through the use of authentication data, most commonly a username in combination with a password or a personal identification number (PIN), which is entered by the user into a client terminal and then communicated from the client terminal to a remote database server.

Authentication data has become the target of increasing criminal activity and so the focus of developments in user authentication systems has been increasing or strengthening the security of such systems. In WO2006/095203 a secure communication system is described in which numerical passwords, PIN numbers and the like are replaced with a sequence of images or symbols which are known only to the user and the merchant or financial institution which assigned the images or symbols to the user as authentication data. In use, a group of images or symbols including the user's assigned images or symbols are displayed to the user at the client terminal on a touch sensitive, clickable, or otherwise navigable display screen. The user is then prompted to enter their authentication data by selecting from the group their assigned images or symbols which comprise their authentication data.

In US patent application publication No. 2004/0093527 it is proposed to make use of a user's personal photograph collection as part of a login procedure. This document describes a system in which from a group of photographs displayed to a user, the user selects their personal photographs as opposed to decoy photographs which are interspersed within the group. There are many disadvantages to this system. One particular problem is that the system relies on the user being able to provide suitable images for incorporation in the database. There are many different image formats and image sizes that the user may utilise for their electronic photographs, making database compatibility an issue. More importantly, as social networking sites such as www.facebook.com and other photo-sharing Internet sites become more popular, it would be relatively easy for someone to gain the necessary knowledge to impersonate another person using this authentication system.

### SUMMARY OF THE INVENTION

The present invention seeks to provide an improved user authentication system and method which enables advertising images to be an integral part of an electronic authentication procedure.

The present invention further seeks to provide a user authentication system and method which enables revenue to be generated through the use of advertising images as part of an electronic authentication procedure.

In a first aspect the present invention provides an authentication server configured to communicate with at least one client terminal for the purposes of authenticating the identity of users of the at least one client terminal, the client terminal including a display for displaying a login screen, the authentication server comprising: first data storage in which is stored image data corresponding to a plurality of different images, the image data including one or more different advertising images; second data storage in which is stored user data including verification data; an image generator adapted to generate an electronic login screen including a plurality of selectable images for display by the client terminal display the plurality of selectable images including a sub-group of selectable images corresponding to the verification data in said second data storage, the image generator being in communication with the first data storage and being adapted to access from the first data storage image data for the selectable images to be included in the electronic login screen; a user verification checking device adapted to compare a sub-group of images selected by a user from the login screen at the client terminal with the verification data stored in the second data storage for that user whereby the user verification checking device authenticates the user when the selected sub-group of images match the verification data; and a counter for generating a count representative of the usage of an advertising image as a selectable image in a login screen.

Preferably, the advertising images comprise images of one or both of products and brands.

For an electronic login screen the image generator may be adapted to access different image data for each selectable image and the image generator may be adapted to use image data of different advertising images for each of the selectable images in an electronic login screen.

In a preferred embodiment the client terminal includes a plurality of user selectable keys and the image generator is adapted to generate an electronic login screen in which each selectable image is associated with a respective selectable key at the client terminal. Where the client terminal includes a touch screen display the selectable images of the electronic login screen may be spatially aligned with user selectable regions or keys of the touch screen display.

Ideally, the second data storage is adapted to store verification data specific to each user and the verification data varies between users. Also, the authentication server may include a user image selection interface adapted to permit a user to choose images from the first data storage, the second data storage being adapted to store the user's selection of images as that user's verification data.

Also, the authentication server may further include an image interface adapted to enable new image data for new selectable images to be added to the first data storage.

Preferably, the first data storage is adapted to store, in association with the image data for each selectable image, classification data and the classification data may be in the form of one or more meta-tags. Moreover, the image generator may be adapted to include in an electronic login screen selectable images having classification data common with the classification data of the sub-group selectable images corresponding to the verification data.

The counting device of the authentication server may be adapted to generate a count of the number of times an advertising image is chosen by a user for inclusion as a selectable image in future electronic login screens. Alternatively, the counting device may be adapted to generate a count of the number of times an advertising image is included in an electronic login screen as a selectable image. The counting device may be adapted to only count occasions when the advertising image appears in a login screen which results in a successful user authentication. Also, the counting device may further include an invoicing system for determining, based on a count for an advertising image, charges to be billed.

The counting device of the authentication server may be a first counting device adapted to generate a count of the number of times an advertising image is chosen by a user for inclusion as a selectable image in future electronic login screens and the authentication server may further comprise a second counting device adapted to generate a count of the number of times an advertising image is included in an electronic login screen as a selectable image

Optionally, the user image selection interface may include searching means adapted to permit a user to search for selectable images in the image data storage means using said classification data.

In a further aspect the present invention provides an authentication method for authenticating the identity of users of a client terminal, the client terminal including a display for displaying a login screen, the authentication method comprising the following steps: receiving a request by a user at the client terminal for authentication; generating an electronic login screen including image data relating to a plurality of selectable images for display by the client terminal display, the plurality of selectable images including a sub-group of selectable images corresponding to user verification data and at least one of the selectable images for display by the client terminal display being an advertising image; receiving a user selection of one or more of the selectable images; comparing the user selection of selectable images with the user verification data; authenticating the user when the user selection of selectable images matches the user verification data; and generating a count representative of the usage of an advertising image as a selectable image in a login screen.

In a yet further aspect the present invention provides a storage medium in which is stored program instructions for implementing the authentication method described above.

In another aspect the present invention provides an authentication system comprising an authentication server and one or more client terminals in bi-directional communication with the authentication server for authenticating the identity of users of the one or more client terminals, the one or more client terminals each including a display for displaying a login screen; and the authentication server comprising: first data storage adapted to store image data corresponding to a plurality of different images, the image data including one or more different advertising images; second data storage adapted to store verification data; an image generator adapted to generate an electronic login screen including a plurality of selectable images for display by the client terminal display the plurality of selectable images including a sub-group of selectable images corresponding to the verification data in said second data storage, the image generator being in communication with the first data storage and being adapted to access from the second data storage image data for the selectable images to be included in the electronic login screen; a user verification checking device adapted to compare a sub-group of images selected by a user from the login screen at the client terminal with the verification data stored in the second data storage whereby the user verification checking device authenticates the user when the selected sub-group of images match the verification data; and a counter for generating a count representative of the usage of an advertising image as a selectable image in a login screen.

### BRIEF DESCRIPTION OF THE DRAWINGS

Embodiments of the present invention will now be described by way of example only with reference to the accompanying drawings, in which:

FIG. 1 illustrates a secure communication system in accordance with the present invention;

FIG. 2 illustrates a first exemplary electronic login page including a user selectable array of keys each having a respective image, generated by the security server of the system of FIG. 1 from image data in its image library;

FIGS. 3A to 3D illustrate alternative exemplary electronic login pages generated by the security server using image data in the image library, in accordance with the present invention;

FIG. 4 illustrates a further exemplary electronic login page generated by the security server from image data in the image library, in accordance with the present invention; and

FIG. 5 illustrates an exemplary information page that is linked to image data in the electronic login page of FIG. 4.

### DETAILED DESCRIPTION

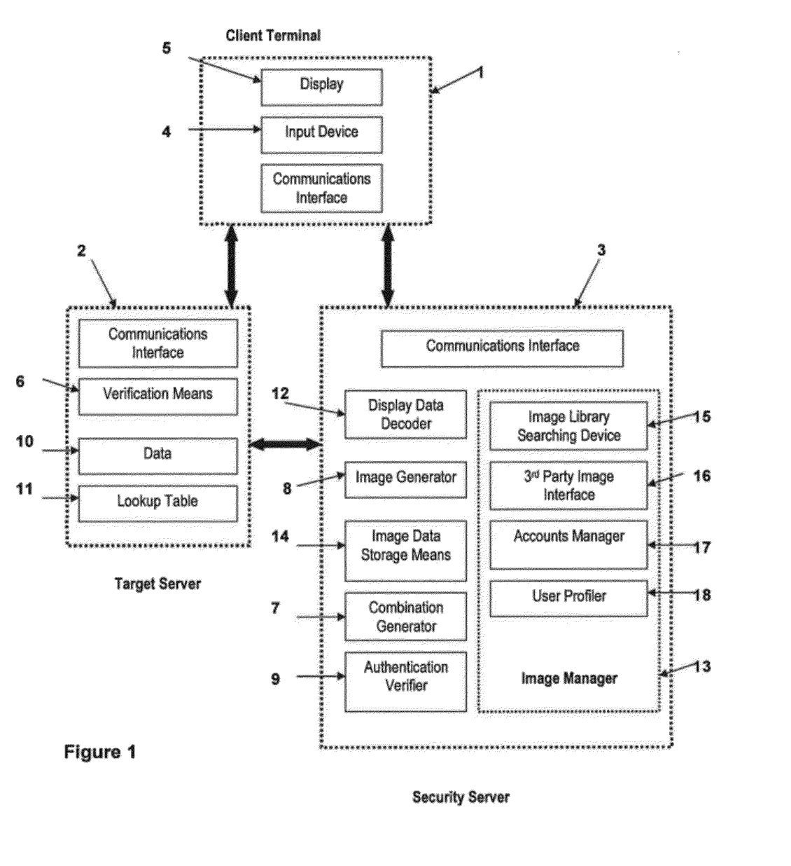

An authentication system for use in a secure communication system is illustrated in FIG. 1 and comprises a client terminal 1, a target server 2 to which a user requires access and a security server 3, all three of which, ideally, are in bidirectional communication with one another. Ideally all communications between the three elements of the system are encrypted using conventional encryption techniques such as, but not limited to, SSL certificates in which case each communication link may use separate and different encryption master codes. It is appreciated that although the security server 3 is shown as an entity separate from the target server 2, this is not essential, and the two may be combined. The target server 2 and the security server 3 may be implemented as standard server platforms such as, but not limited to, the Windows or Linux operating systems running on either stand-alone conventional hardware or a conventional appliance.

The client terminal 1, target server 2 and security server 3 may be remote from one another employing any conventional communications interface delivering wireless or wired networking functionality for communication that is suitable for text and image data transmissions such as an encrypted tunnel via the Internet or a private MPLS or Frame Relay circuit.

The client terminal 1 is adapted, either in hardware or software, to access the target server 2. Once a user has been authenticated and access has been granted, activities a user may wish to perform may be, but are not limited to, making changes such as deletions and additions to the user's data stored at the target server 2; to run instructions such as purchasing instructions; and/or to retrieve and/or record messages. The client terminal 1 includes a display 4 and an input device 5. Devices suitable for use as the client terminal include, but are not limited to, ATMs, computers, laptops, netbooks, mobile phones and PDAs. Indeed, any device may be adapted to function as the client terminal 1 where the device has bidirectional communication capability involving at least text and image data and having a display 4 and a user controls 5 such as, but not limited to, control keys, a keyboard, a pointing device such as a mouse, and/or a touch sensitive display.

The display 4 of the client terminal 1 may be any device capable of modifying its appearance in order to convey varying information to a user. The display 4 may comprise a conventional visual display unit (VDU). However, it is preferred that the display 4 consists of a touch sensitive display or modifiable legends on a keypad or keyboard in which case the display 4 and input device 5 are integrated into a unitary unit performing both display and user input functions.

The input device 5 is used by the user to input authentication data. The authentication data is then communicated from the client terminal 1 to either the security server 3 or the target server 2 to enable the identity of the user to be verified. The client terminal 1 may optionally include means for receiving and reading a card or other physical identification means, carrying partial authentication data. For example, the client terminal 1 may be an electronic in-store order terminal. In this example the card reader of the in-store terminal reads data stored on the card such as identification details of the cardholder, e.g. name and account number. However, the data carried on the card represents only part of the authentication data. Access to the target server 2 is only granted once the user has entered further authentication data using the input device 5 of the client terminal 1.

The target server 2 includes verification means 6 for verifying the identity of a user attempting to access the database server 2. The verification means 6 has stored within it, or has access to a memory in which is stored, identity data for existing customers or users. The verification means 6 may additionally have stored or have access to users' valid authentication data. Optionally, the authentication data may be stored separately from the users' identity data. Using a method which will be described in greater detail later, where a user has entered valid authentication data via the client terminal 1 which has been successfully matched to the user's stored identity and authentication data, the user is then granted access to data 10 stored on the target server 2. In most instances the user is only granted access to data specific to them, such as a user's personal bank/merchant account details.

It is to be appreciated that although the verification means 6 has been described as a component of the database server 2, it may take the form of a separate authentication server which gates access to data 10 stored at a separate target server 2, and only permits access to the user of a client terminal where that user has presented valid identity and authentication data.

The security server 3 generally comprises a combination generator 7, an image generator 8 an authentication verifier 9, a display data decoder 12, an image manager 13 and data storage means 14.

In order to complete the authentication of a user using the secure method described herein, the user must enter their personal authentication data (PAD) into the client terminal. The PAD comprises a series of images the ordering of which, optionally, may also be significant. To enable the user to enter their PAD, the display 4 of the client terminal 1 displays a group of user selectable keys each being identifiable by or associated with one or more images and some, but not all, of the images displayed will match the user's own PAD images.

When a user makes a request to login to the target server 2, an authentication login request is issued to the security server 3. This request may be sent via the target server 2 or the target server 2 may instruct the client terminal 1 to issue a request directly to the security server 3. When a request for an authentication login is received by the security server 3, the combination generator 7 generates a string of image data and assigns an identification code specific to the image string. The ordering of the image data in the string may be randomised preferably using conventional electronic quasi-random number generation routines. Where the ordering of the image data in the string is randomly selected, the ordering of the user selectable keys displayed to the user on the display 4 may be similarly randomly arranged.

The combination generator 7 communicates the image string, the string identification code and other login screen design data to the image generator 8. The string identification code is communicated to the authentication verifier 9 which, in turn, communicates the string identification code back to the target server 2 which, in turn, will pass the string identification code to the client terminal or the string identification code is communicated directly to the client terminal 1 (whichever issued the authentication login request to the security server 3). In the preferred embodiment of the secure authorisation system the string identification code corresponds to an electronic remote address in the form of a uniform resource locator (URL), the use of which will be described later.

When the image generator 8 receives the user's design data, the random string and the string identification code, the image generator 8 creates a login page to be displayed on the client terminal display 4 which is specific to the user and to that login event. The login page created by the image generator 8 is then mapped to the electronic remote address corresponding to the string identification code generated by the combination generator 7. This means that when the client terminal 1 receives the string identification code the client terminal 1 uses the string identification code to access the login page which has been created by the image generator 8 specifically for that login event.

As mentioned earlier, at least part of the design data communicated to the image generator 8 from the combination generator 7 identifies image data relating to the selectable symbols and/or images which form the user's authentication data. Ideally, the user's authentication data comprises a sequence of four images but it will be appreciated that the sequence may consist of greater or fewer numbers of symbols and/or images and that the sequence need not be unique to the user. The image generator 8 therefore uses the user's design data to extract from the image data storage means 14 the image data for the symbols or images which must be assigned to selectable keys on the login page to be created by the image generator 8 for that user. The image data will be in a form suitable for display on the client terminal 1. For example, the image data may consist of image files in conventional image data formats such as JPG, GIF, BMP, TIFF which are then embedded in a structured file for display as a login page, such as an HTML document.

In an alternative embodiment, the authentication verifier 9 reads from the data storage means 14 the image data for the symbols or images constituting the user's authentication data. This image data is then communicated to the image generator along with the user's design data and the string identification code.

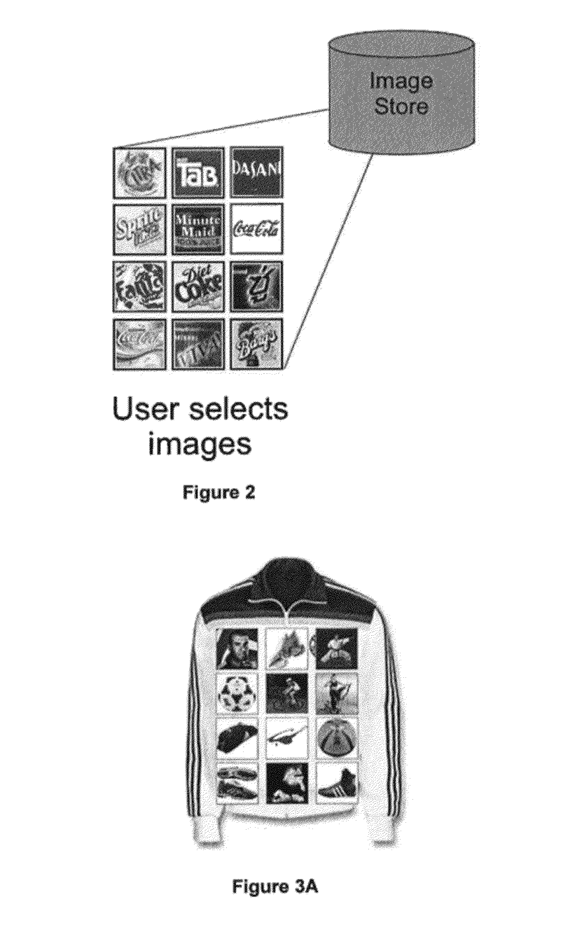

In addition to the image data specific to a user's authentication data, the image generator 8 will extract from the image data storage means 14 image data for other symbols and/or images which function as padding symbols and/or images. The padding symbols/images make up the images to be assigned to the remainder of the keys in the array to be presented to the user in the login page. It is recommended that each padding image be different so as to avoid it being immediately apparent through repetition which images having been added as padding images. Optionally, the user's design data may identify a theme or classification that restricts the library of images from which padding images may be selected by the image generator 8. This ensures that the padding images have a theme or classification which is common to the theme or classification of the user's authentication data. In this way, fraudulent identification of the user's authentication data is made more difficult as the images of all of the user selectable keys will be related. Of course, this restriction in the selection of images from the image storage means 14 will not be necessary where the library of images are already all linked by a common theme or classification. For example, the authentication system may be used to provide access to an on-line store. This enables the library of images for use in constructing the login screen to be thematically linked by limiting the contents of the image library to images of products available in the store. FIG. 2 is a simple example of this thematic linking in the case of an online store selling soft drinks: each of the twelve user selectable key displayed to the user has been assigned a different brand image of different drinks available from the online store. Thus all twelve images are thematically linked but each is different and only a sub-set of the twelve images, e.g. four, constitute a user's authentication data. By using thematically linked image data, an online store is able to use the login process to advertise their products in a direct manner. Moreover, such as approach is much more likely to hold the attention of a user, because the user must interact with the login page in order to proceed through to the store's main website.

The random string generated by the combination generator 7 determines the allocation of the images read from the data storage means 14 by the image generator 8 to the user selectable keys of the login page. In this way, the ordering of the images on the array of user selectable keys is randomised. This enables the selected padding images as well as the ordering of all of the images to be changed for different login events for the same user. Whilst random ordering of the images may not always be necessary, for example in circumstances where only low security is required. However, random ordering of the images offers the additional advantage of heightened user awareness because it prevents users from becoming familiar with the same spatial arrangement of their PAD images. Hence the user must look at all of the images displayed on the login window to identify and select their PAD images.

The design data for each user may additionally define subsidiary features of the login page to be displayed by the client terminal 1 when the user of the client terminal is prompted to enter their authentication data to complete the login procedure. Thus, the login webpage/screen image that is presented to each user is tailored to each user and may be unique to each user. Examples of what the design data may define are: the font size of the lettering/numbering; the background colour; the colour of the individual selectable symbol keys; the colour of a border around the symbol keys; the shape of the individual symbol keys; the shape of any border around the symbol keys; as well as any decorative details such as patterning or additional images. It will, of course, be apparent that the design variations of the login webpage/screen image are not limited to the examples given above and that there are an extremely large number of design features that can be varied without detracting from the function of the login webpage/screen image, which is to enable a user to enter their authentication data.

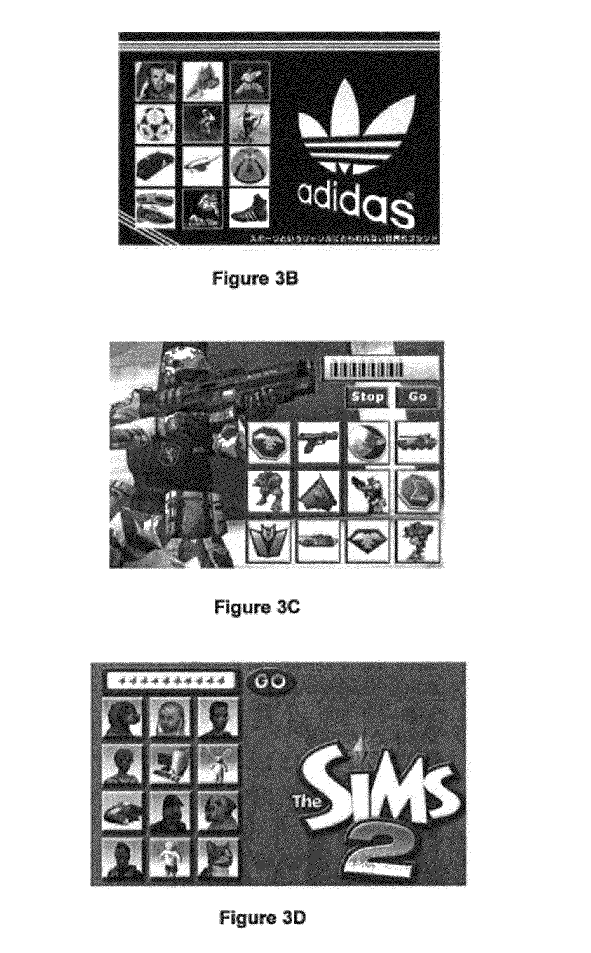

In this regard, FIGS. 3A to 3D illustrate a number of different examples of login pages that may be generated. FIG. 3A is a sporting themed login page comprising an array of twelve separate user selectable keys 5a each bearing a different football themed image. The keys 5a are framed by the image of a sports jacket with striping on the sleeves of the jacket representative of an Adidas™ trademark. In order to enter their personal authentication data (PAD) a user selects, in a predetermined sequence, the four keys that bear the four football images which form their personal authentication data. FIG. 3B illustrates an alternative login webpage, again with football themed images on each of the twelve user selectable keys 5a, but this time the keys are positioned in a rectangular frame alongside the Adidas™ logo. FIGS. 3C and 3D illustrate two further alternative themed login pages, this time involving symbols and/or images taken specific to two computer games.

Using the string identification code the client terminal 1 accesses the URL and displays the login page which has been constructed for that user by the image generator 8. The user then enters his authentication data by selecting, using the input device 5, a sub-group of the selectable images displayed. The images are selected by selecting the individual keys that bear or are associated with the symbols and/or images that make up the user's authentication data, optionally in the predetermined sequence of the user's personal authentication data. The key selection entered by the user is recorded as positional data by the client terminal 1, that is to say the positions of the keys selected by the user in the array of selectable keys are recorded. This positional data may then be converted by the client terminal 1 into character data or some other form of data for sending to the security server 3. The positional data or the character data into which the positional data is converted represents an encoded form of the authentication data and it is this encoding of the authentication data which is communicated back to the security server 3. Thus, the actual images constituting the user's authentication data are not communicated back to the security server 3 only an encoding in terms of the positions of the images on the login page.

The display data decoder 12 of the security server 3 receives the encoded form of the authentication data from the client terminal 1. Using information supplied by the image generator 8 regarding the arrangement of images on the login page for this login event, the display data decoder 12 decodes the positional data/character data to identify the images of the keys selected by the user. The authentication verifier 9 then compares the user's selection of images against the user's authentication data. Where the images selected by the user during the login event matches the stored authentication data, confirmation of the match is communicated back to the target server 2 by the security server 3 thereby completing full verification of the user requesting access to the database server 2. Once full verification is completed the user at the client terminal is granted access to the target server 2. Alternatively, if a match is not confirmed the user is refused access.

In an alternative embodiment, the user's authentication data may be stored in the target server 2 in combination with the user's design data. In this case the user's selection of images during the login event is communicated from the security server 3 to the target server 2 using the session id unique to the communication session between the target server and the security server. The target server 2 then compares the authentication data received from the security server 3 with the authentication data it already has stored for that user. Assuming the authentication data entered the user is correct, the target server 2 then grants access or refuses access where the authentication data is incorrect.

In this way, a user's authentication data is hidden in an array of images from which the user is required to select the image sequence making up their authentication data. The communication system is designed such that the user's authentication data does not appear in any communication between the client terminal and the security server separately from other image data. This makes it extremely difficult for someone fraudulently monitoring communications between the security server and remote client terminals to identify a user's personal authentication data (PAD).

The images in the data storage means 14 may be tagged with one or more additional data fields; the data fields preferably being expressed as meta-tags. The additional data fields preferably include classification or categorisation data, which serves to segment the data into different subject areas. In this way the images may be conceptually or thematically related so that, as mentioned earlier, the padding images may be conceptually or thematically linked to a user's authentication data making identification of the user's authentication data from amongst the padding images very difficult. For instance, if a user's authentication data includes one or more images with a “sport” categorisation, the image generator may randomly select the padding images from other images having a “sport” categorisation. Similarly, where the user's image sequence includes multiple categorisations, the image generator 8 may use one or more of these multiple categorisations to randomly select the padding images. This has the advantage of making it more difficult for potential fraudsters to guess a particular combination of images that may make up the user's authentication data, due to all of the images assigned to the selectable keys being similarly themed. That is, there are no necessarily unique or obviously different images that stand out.

A further advantage of using meta-tags in association with the image data arises where product/brand images are used as this enables advertisers to reinforce the identity of their products and/or services and for the owners of target servers to generate advertising revenue from the use of such images.

As mentioned earlier, the secure communication system employs a library of images much larger in number than the number of images required to construct a single login page. The existence of the library of images offers the opportunity for a user to select their own authentication data from the library. Thus, a user who is registering for the first time can be offered access to the contents of the image data storage means 14, via the image manager 13. This enables a user to select their own series of images to form their new personal authentication data. Once the user has selected new personal authentication data, this is recorded so that on future occasions when the same user attempts to login to the target server 2 the image generator 8 constructs the login page to include the images selected by the user as their new personal authentication data.

The image manager 13 may include a image library searching device 15 which is adapted to enable a user, via a client terminal, to search through the library of images, using conventional image searching software, and to select from the library their personal authentication data (PAD) for future login events. The same functionality may be used to enable existing users to change their PAD images for future login events. In the latter case, the image manager 13 overwrites the user's existing PAD in the image data storage means 14 with the user's newly selected personal authentication data. The classification meta-tags assigned to the individual images in the library, mentioned earlier, offer a particularly convenient means for searching the library of images. All images in the image storage means 14 may be made available to the user, or only certain images as defined by predetermined criteria. For instance, users known to be under 18 years of age may be excluded from searching images having a meta-tag which identifies the image as containing adult subject matter, for example a meta-tag indicating an “alcoholic drink” classification. Restriction of access to the full library of images may be controlled by the image manager 13 using predetermined rules which link categories of users to restricted lists of meta-tags. Restricting access to the full library also offers the benefit of improved security.

As has been shown, this user authentication system is suitable for use with branded and product specific images. In view of this, a further feature of the authentication system is the opportunity for branded and product specific images to be added to an existing library of images. Thus, commercial operators may make use of the categorised images, by having their own product and brand images added to the image data storage means 14 under categories of relevance to their business. This offers a wholly new means of advertising electronically in circumstances where user awareness is higher than normal. Thus, the image manager 13 additionally includes a 3^{rd} party image interface 16 which is adapted to receive product and brand images uploaded by advertisers. Assuming the product and brand images meet the image data format requirements of the system, the 3^{rd} party image interface 16 records the product or brand image in the image data storage means 14 and preferably assigns one or more meta-tags to the image data which identifies the 3^{rd} party, e.g. an advertiser, that supplied the image data. Alternative means of identifying the origin of the image data is, of course, also envisaged.

Revenue may be raised by the operator of the security server 3 in permitting advertisers to place their images in the image library. Hence, the image manager 13 may additionally include an accounts manager 17 which monitors the uploading and the use of advertising images. Hence, the accounts manager 17 may assign a basic charge to the uploading of a new product or branded image to be billed to the advertiser uploading the image. The accounts manager 17 may record further charges each time an advertising image is used as a padding image in a login page or a premium may be charged to an advertiser who wishes to ensure that their images are used regularly, as opposed to randomly, as padding images. Also, where the image library includes a wide range of different categories of images, the accounts manager 17 may allocate different charges to a new image uploaded by an advertiser in dependence upon the popularity of the category of the image and the meta-tags assigned to the image.

The accounts manager 17 may also be adapted to monitor and charge for the active use of an advertising image. Thus, the accounts manager 17 may maintain records of the number of occasions an advertising image is selected for inclusion in a user's personal authentication data. Alternatively or additionally, where an advertising image forms part of a user's personal authentication data, the accounts manager 17 may maintain a count of the number of occasions the advertising image is presented as part of a login event or clicked as part of a login event. This count is then used to calculate a charge. With this latter embodiment, the accounts manager 17 is required to maintain a record of all ‘clicks’ on the advertising images i.e. a record is kept of each time a user selects an advertising image as part of a login procedure. This information is also useful as marketing data: it offers objective assessment of the advertiser's exposure. To overcome possible abuses of this system, the accounts manager 17 is preferably adapted to only count clicks arising in successful login attempts.

The user authentication system described herein also offers the opportunity for users to select their own padding images from the image storage means 14 as well as their own authentication data. The accounts manager 17 may, therefore, also maintain a record, for charging purposes, of how often an advertising image is selected by a user for inclusion as a padding image. However, as the padding images are not selected during a login event, it is not possible to determine charges to an advertiser on a per click basis in relation to padding images.

Information regarding the choices of a user is also of commercial value and so the image manager 13 may additionally include a user profiler 18 which is configured to maintain information on all the images selected by a user for use as part of their login procedure and/or the tagged categorisation data relating to the selected images. This information provides an indication of users' perception and response to the images available to them e.g. which products and branded images attracted the attention of the users. The information can also be used to identify the particular interests of each user which, in turn, enables the user's experience of the login procedure to be tailored to their particular interests.

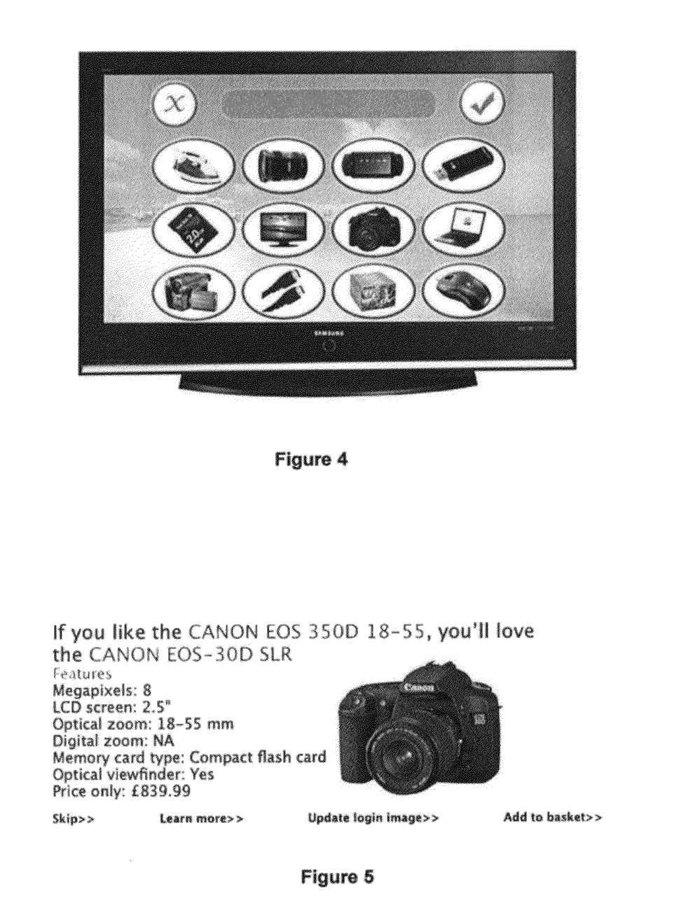

Hence, the user profiler 18 monitors the images selected by a user for inclusion in their personal authentication data and the profiler 18 is adapted to push sales information to the client terminal specific to the interests of that user. For example, the profiler 18 may use the meta-tags assigned to each image in the user's personal authentication data to trigger cross-selling messages specific to the user. An example of this functionality is illustrated in FIGS. 4 and 5. In FIG. 4 a login page for an online store is shown consisting of an array of twelve selectable keys with each key assigned an image of a different product that may be purchased through the online store. In this example it is assumed that the user is a returning customer who, on a previous occasion, selected the images that form the user's personal authentication data. Each of the images is of a different product and includes meta-tag data such as the product name, product code, product description, price, categorisation etc. When the user selects the product images specific to their personal authentication data, this may cause the user profiler 18 to trigger a new page to be sent to the client terminal or one or more pop-up windows to be pushed to the client terminal, which can be used to provide the user with additional information such as new or time sensitive information about the products. The additional information can be used to notify the user of a particular promotion that is available on one of the products forming the user's authentication data. Alternatively, the additional information may alert the user to the fact that an upgraded version of the product has just been released. In this regard, FIG. 5 shows a new webpage to be displayed by the client terminal 1 triggered by the user entering their authentication data. This webpage is linked to the camera image in the array of keys shown in FIG. 4 (third image from the left in the second row). Once the new webpage is displayed by the client terminal, the user may be offered the opportunity to perform one or more actions in response to the cross-selling message: the user may be offered the opportunity to update their login keypad images to include the new product; the user may be offered the opportunity to find out more about the new product; and/or the user may be offered the opportunity to add the new product to their online “shopping trolley” for purchase.

Preferably, the new webpage is triggered by the user profiler 18 and the URL for the new webpage is communicated to the target server 2 along with confirmation that the user has entered valid authentication data. The new URL is then communicated to the client terminal via the target server 2 as part of the confirmation that the identity of the user at the client terminal has been fully verified.

In an alternative embodiment of the invention, the 3^{rd} party image interface 16 is adapted to permit users to upload their own images to the image library and to assign tags to the images for example to restrict access to the images to only identified users. For instance, the user uploading an image may designate a buddy list of persons able to access the image. With this functionality, the accounts manager 17 can be adapted to record the number of times an image uploaded by a user is selected for inclusion in another user's authentication data or as a padding image or the number of times the image it is used during valid logins. This can then be used to construct a “Top 10” of user supplied images. This embodiment enhances the user experience in accessing a website where user verification is required and has particular application to online community websites.

The user authentication system described herein offers advantages additional to improved security. In particular, the system offers new opportunities for merchants to use the login procedure to advertise their products and to target users based on the users' own interests reflected in their choice of authentication data; and general merchant websites may raise additional revenue through charges to advertisers whose advertising images are used as part of the login procedure.

Although one exemplary embodiment or the present invention has been described in detail above, those skilled in the art will readily appreciate that many modifications are possible without materially departing from the novel teachings and advantages of this invention. Examples only of many possible modifications are set out below. The target server and the security server may be combined so that all communication to and from the client terminal are via a single bi-directional communication link. Also, the particular combination of features of the security server described herein may be varied. For example, it is not essential for the arrangement of the selectable images to be randomised and so the combination generator may be omitted. Similarly, many different ways of constructing the login page are envisaged with varying levels of security. For example, conventional software for posting advertising images onto different login pages as padding images may be employed. The sub-group of images that must be selected for successful authentication of a user need not be unique to the user. Indeed, the same sub-group of images may be used for all users requesting access to the target server. All such modifications are intended to be included within the scope of this invention as defined in the following claims.

1. An authentication server configured to communicate with at least one client terminal for the purposes of authenticating the identity of users of the at least one client terminal, the client terminal including a display for displaying a login screen, the authentication server comprising:
first data storage in which is stored image data corresponding to a plurality of different images, the image data including one or more different advertising images;
second data storage in which is stored user data including verification data;
an image generator adapted to generate an electronic login screen including a plurality of selectable images for display by the client terminal display the plurality of selectable images including a sub-group of selectable images corresponding to the verification data in said second data storage, the image generator being in communication with the first data storage and being adapted to access from the first data storage image data for the selectable images to be included in the electronic login screen;
a user verification checking device adapted to compare a sub-group of images selected by a user from the login screen at the client terminal with the verification data stored in the second data storage for that user whereby the user verification checking device authenticates the user when the selected sub-group of images match the verification data; and
a counter for generating a count representative of the usage of an advertising image as a selectable image in a login screen.

2. An authentication server as claimed in claim 1 wherein the advertising images comprises images of one or both of products and brands.

3. An authentication server as claimed in claim 1, wherein for an electronic login screen the image generator is adapted to select different image data for each selectable image.

4. An authentication server as claimed in claim 1, wherein the image generator is adapted to select image data of different advertising images for each of the selectable images in an electronic login screen.

5. An authentication server as claimed in claim 1, wherein the client terminal includes a plurality of user selectable keys and the image generator is adapted to generate an electronic login screen in which each selectable image is associated with a respective selectable key at the client terminal.

6. An authentication server as claimed in claim 5, wherein the client terminal includes a touch screen display and the selectable images of the electronic login screen are spatially aligned with user selectable regions of the touch screen display.

7. An authentication server as claimed in claim 1, wherein the second data storage is adapted to store verification data specific to each user and the verification data varies between users.

8. An authentication server as claimed in claim 7, further including a user image selection interface adapted to permit a user to choose images from the first data storage, the second data storage being adapted to store the user's selection of images as that user's verification data.

9. An authentication server as claimed in claim 1, further including an image interface adapted to enable new image data for new selectable images to be added to the first data storage.

10. An authentication server as claimed in claim 1, wherein the first data storage is adapted to store, in association with the image data for each selectable image, classification data.

11. An authentication server as claimed in claim 10, wherein the first data storage is adapted to store classification data in the form of one or more meta-tags

12. An authentication server as claimed in claim 10, wherein the image generator is adapted to include in an electronic login screen selectable images having classification data common with the classification data of the subgroup selectable images corresponding to the verification data.

13. An authentication server as claimed in claim 11, wherein the image generator is adapted to include in an electronic login screen selectable images having classification data common with the classification data of the sub-group selectable images corresponding to the verification data.

14. An authentication server as claimed in claim 1, wherein the counting device is adapted to generate a count of the number of times an advertising image is chosen by a user for inclusion as a selectable image in future electronic login screens.

15. An authentication server as claimed in claim 1, wherein the counting device is adapted to generate a count of the number of times an advertising image is included in an electronic login screen as a selectable image.

16. An authentication server as claimed in claim 15, wherein the counting device is adapted to only count those occasions when the advertising image appears in a login screen which results in a successful user authentication.

17. An authentication server as claimed in claim 1, wherein the counting device further comprises an invoicing system for determining, based on the count for an advertising image, charges to be billed.

18. An authentication server as claimed in claim 1, wherein the counting device is a first counting device adapted to generate a count of the number of times an advertising image is chosen by a user for inclusion as a selectable image in future electronic login screens and the authentication server further comprising a second counting device adapted to generate a count of the number of times an advertising image is included in an electronic login screen as a selectable image.

19. An authentication server as claimed in claim 18, wherein the second counting device is adapted to only count those occasions when the advertising image appears in a login screen which results in a successful user authentication.

20. An authentication server as claimed in claim 18, wherein the first and second counting devices further comprise an invoicing system for determining, based on the count for an advertising image, charges to be billed.

21. An authentication server as claimed in claim 8, wherein the first data storage is adapted to store, in association with the image data for each selectable image, classification data and the user image selection interface is adapted to enable a user to search for selectable images in the first data storage using said classification data.

22. An authentication method for authenticating the identity of users of a client terminal, the client terminal including a display for displaying a login screen, the authentication method comprising the following steps:
receiving a request by a user at the client terminal for authentication;
generating an electronic login screen including image data relating to a plurality of selectable images for display by the client terminal display, the plurality of selectable images including a sub-group of selectable images corresponding to user verification data and at least one of the selectable images for display by the client terminal display being an advertising image;
receiving a user selection of one or more of the selectable images;
comparing the user selection of selectable images with the user verification data;
authenticating the user when the user selection of selectable images matches the user verification data; and
generating a count representative of the usage of an advertising image as a selectable image in a login screen.

23. A tangible storage medium in which is stored program instructions for implementing the authentication method of claim 22.

24. An authentication system comprising an authentication server and one or more client terminals in bi-directional communication with the authentication server for authenticating the identity of users of the one or more client terminals,
the one or more client terminals each including a display for displaying a login screen; and
the authentication server comprising:
first data storage adapted to store image data corresponding to a plurality of different images, the image data including one or more different advertising images;
second data storage adapted to store verification data;
an image generator adapted to generate an electronic login screen including a plurality of selectable images for display by the client terminal display the plurality of selectable images including a sub-group of selectable images corresponding to the verification data in said second data storage, the image generator being in communication with the first data storage and being adapted to access from the second data storage image data for the selectable images to be included in the electronic login screen;
a user verification checking device adapted to compare a sub-group of images selected by a user from the login screen at the client terminal with the verification data stored in the second data storage whereby the user verification checking device authenticates the user when the selected sub-group of images match the verification data; and
a counter for generating a count representative of the usage of an advertising image as a selectable image in a login screen.
